(19) United States
(12) Patent Application Publication
(10) Pub. No.: US 2004/0054751 A1
(43) Pub. Date: Mar. 18, 2004

(54) Method for processing and accessing data in a computerised reservation system and system therefor

(76) Inventors: Francois Weissert, Nice (FR); Vincent Lextrait, Nice (FR); Pierre Dor, Nice (FR); Yannick Girard, Nice (FR); Veronique Marquion, Nice (FR); Anne McCulloch, Nice (FR); Slavko Konc, Nice (FR)

Correspondence Address: YOUNG & THOMPSON, 745 SOUTH 23RD STREET 2ND FLOOR, ARLINGTON, VA, 22202

(21) Appl. No.: 10/250,980

(22) PCT Filed: Jan. 10, 2002
(86) PCT No.: PCT/FR02/00067

(30) Foreign Application Priority Data
Jan. 10, 2001 (FR) 0100236

(51) Int. Cl. G06F 17/60; G06F 15/16

(52) U.S. Cl. 709/217; 705/5

(57) ABSTRACT

The invention concerns a method for processing and accessing data in a computerized reservation system, and a computerized system for its implementation. The invention is characterized in that it consists: in creating at least a cache (9a,9b) in the server protion, said chache (9a,9b) containing reservation, data; addiing data to the cache (9a, 9b) by transfer from at least an inventory setup (1); creating an interfacing application (18) between the cache (9a, 9b) and the client application(s) so that the user can address requests and recieve data in response. The invention is applicable to computerized reservation systems in particular in the field of transport, travel, and accomidation.

The present invention relates first of all to a process for processing and accessing data in a computer preservation system.

It also relates to a computer reservation system adapted to use this process.

Computer reservation systems at present are used particularly in the field of travel, air transport or else for lodging reservations.

In this field, there exist one or several inventory bases corresponding to the condition of reservations at each of the service providers such as the airline or the car rental company. A central system permits accessing different inventory bases for processing the information and to respond to the requirements of users. These latter can thus interrogate the central system by the use of client applications to obtain data particularly as to availability, cost, and types of service offered.

The whole of this access and data transfer takes place by a communication network.

According to the present state of the art, the central system receives multiple requests from a plurality of users and, to respond to them, directly interrogates one or several inventory bases.

This principle of operation has the drawback of rendering more cumbersome and difficult the communication network, principally in connection with inventory bases. This point is the more damaging as certain requests of users do not require direct access in a synchronous manner to the inventory databases.

For example, users connecting by means of a wide extension network such as the Internet sometimes interrogate the reservation system for the sole purpose of learning the types of reservations and the costs. It is thus not strictly necessary to give them at the same time certain information as to availability of reservations.

The present state of the art comprises particularly U.S. Pat. No. 5,570,283. This latter discloses a computer system provided with modular software permitting, both to travelers electronically accessing an inventory to obtain airfares very rapidly in a convivial software environment, and agents or professional to make reservations and to access specific databases connected with their professional activities.

This document relates essentially to the problem of the price of the items offered. Thus, it seeks to have prices completely up to date for agents and other professionals.

However, according to this document, it is still necessary to have direct access to the inventory bases for the condition of reservations for any type of request.

The present invention overcomes the drawbacks of the present techniques.

It permits decreasing the volume of direct access to the inventory bases of the condition of reservations by providing a database of the “CACHE” type adapted to respond to the first interrogations of the users.

Moreover, the access to this cache has the advantage of being able to be carried out by means of a communication network of the wide extension type such as the Internet for which the cost of communication is very small.

Other objects and advantages will become apparent from the description which follows, which describes a preferred embodiment of the invention but however is not limiting.

The present invention relates to a process for processing and accessing data in a computer reservation system, comprising a server portion provided with a central system and at least one inventory base of the condition of registrations, and a client portion comprising at least one client application, the server and client portions being connected by a communication network, characterized by the fact that:

there is created at least one cache in the server portion, said cache containing reservation data;

there are added data to the cache by transfer from at least one inventory base;

there is created an application interface between the cache and the client application or applications so that the user can address requests to the cache and receive data in response.

This process can be present in the modifications set forth as follows:

if, during a request to the cache from an application client, the cache does not contain the data requested:

the request is processed in the central system by access to the inventory bases of the condition of registrations to find the requested data;

said data are added to the cache;

the requested data are returned, in response, to the application client.

the data contained in the cache are cleaned by the use of the following procedure:

assigning a maximum duration of retention to each datum contained in the cache;

period search of the data contained in the cache to detect the data whose maximum duration of preservation has expired;

deletion of the data whose maximum duration of preservation has expired.

the data contained in the cache are cleaned by the following procedure:

assignment of a limit size and a threshold size to the cache, said threshold size having a value lower by a predetermined margin than said limit value;

when the limit size is reached, deletion of the data contained in the cache by decreasing order of last time used, to reach the threshold size.

the data are arranged in the cache by:

assignment of a key to each datum to be stored;

transformation of the key into a numerical value;

creation of a vector of lists comprising a series of compartments adapted to contain a list of several data;

assignment, to each compartment, of a whole number index starting from zero;

determination, for each datum, of the index of the storage compartment by modulation of the numerical value of the key of the data by the number of compartments;

storage of the data in the compartment thus determined.

data are searched in the cache by transformation of the key to a numerical value and determination of the index of the storage compartment by modulation of the numerical value of the key by the number of compartments and by the fact that:

if a single datum is present in the compartment, the sought datum is retrieved;

if no datum is present in the compartment, an absence of information is returned;

if several data are present in the compartment, their keys are compared to determine that which is effectively sought.

Access is blocked only of the compartments in the course of processing a request to permit other processing of requests simultaneously in other compartments.

The invention moreover relates to a computer reservation system comprising a server portion provided with a central system and at least one inventory base of the condition of reservations, and a client portion comprising at least one client application, the server portions and client portions being connected by a communication network, adapted to use the process according to the invention.

Characterized by the fact that it comprises

at least one cache in the server portion, said cache containing reservation data;

at least one application interface between the cache and the client application or applications so that its user can address requests to the cache and receive data in response.

According to modifications:

at least one cache block provided with a cache and an application of management of the cache;

at least one entry management block provided with a plurality of entry management modules each receiving requests from one or several client applications and controlled by an inlet control.

each inlet management module is assigned to a single client application.

inlet management modules are assigned to several client applications and their cache block comprises:

a file adapted to receive requests from client applications and to redistribute them by order of entry upon demand of the cache;

the cache or caches comprise a vector of lists comprising a suite of compartments adapted to contain a list of several data and to which is assigned an index, for searching of data by the index of the compartment where it is stored.

it comprises a cleaning tool adapted to address the cleaning commands to the cache according to a predetermined procedure.

The accompanying drawings are given by way of examples. They show embodiments which permit easy comprehension of the invention.

FIG. 1 shows an example of processing requests from clients according to the present state of the art.

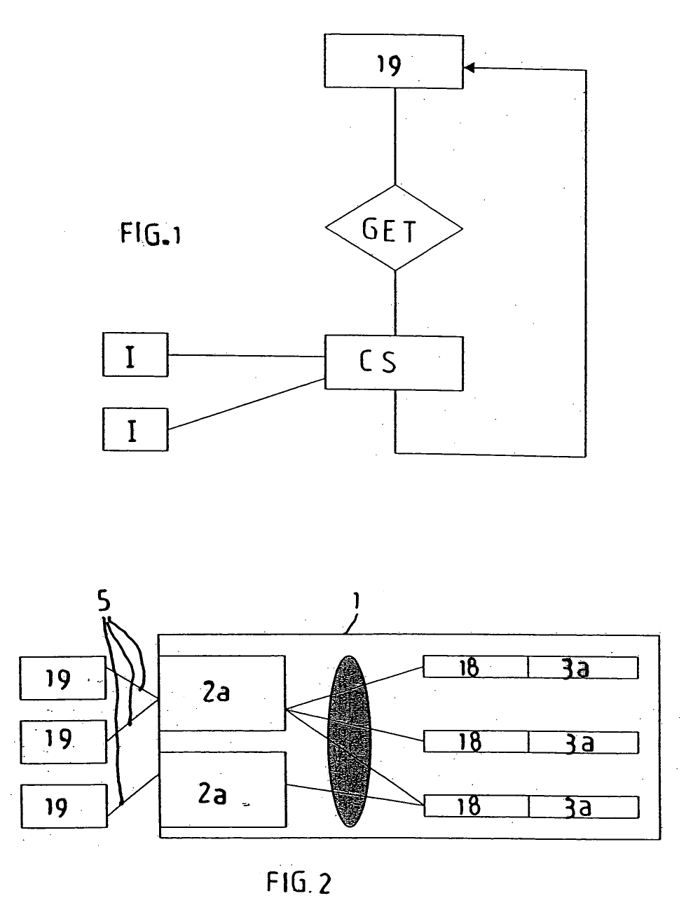

FIG. 2 schematically shows the members of the system of the invention in a particular embodiment.

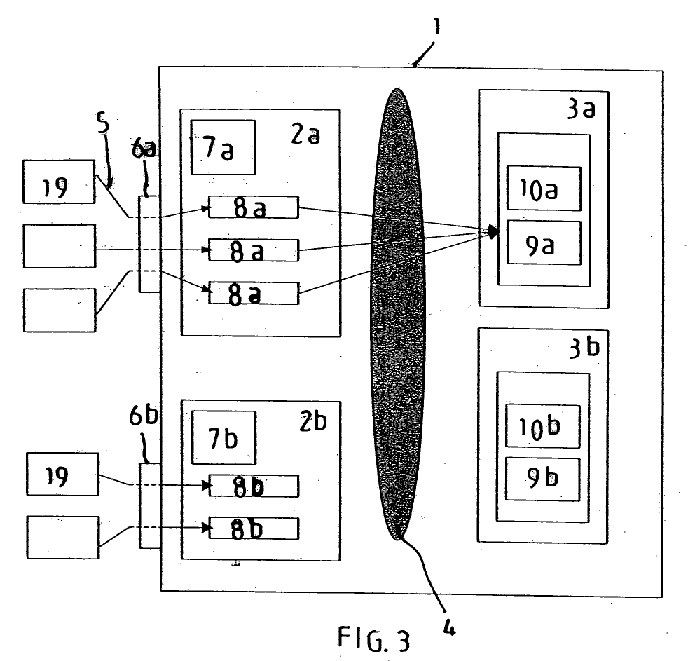

FIG. 3 is another schematic drawing of the embodiment of the system according to the invention which specifies certain members.

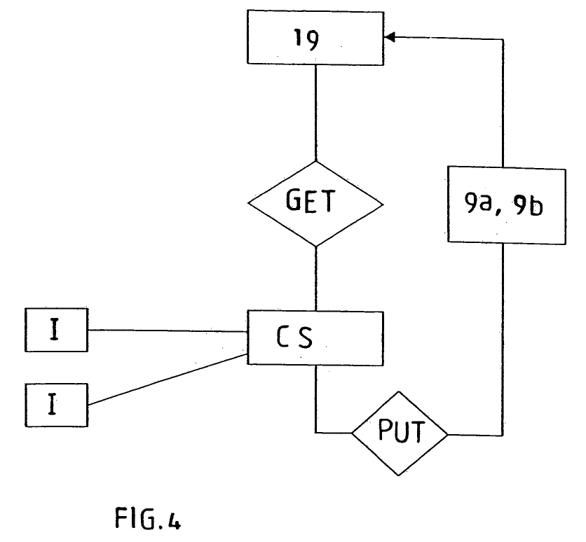

FIG. 4 is a synoptic diagram of the phases of interrogation and of display of the cache in the system and according to the present invention.

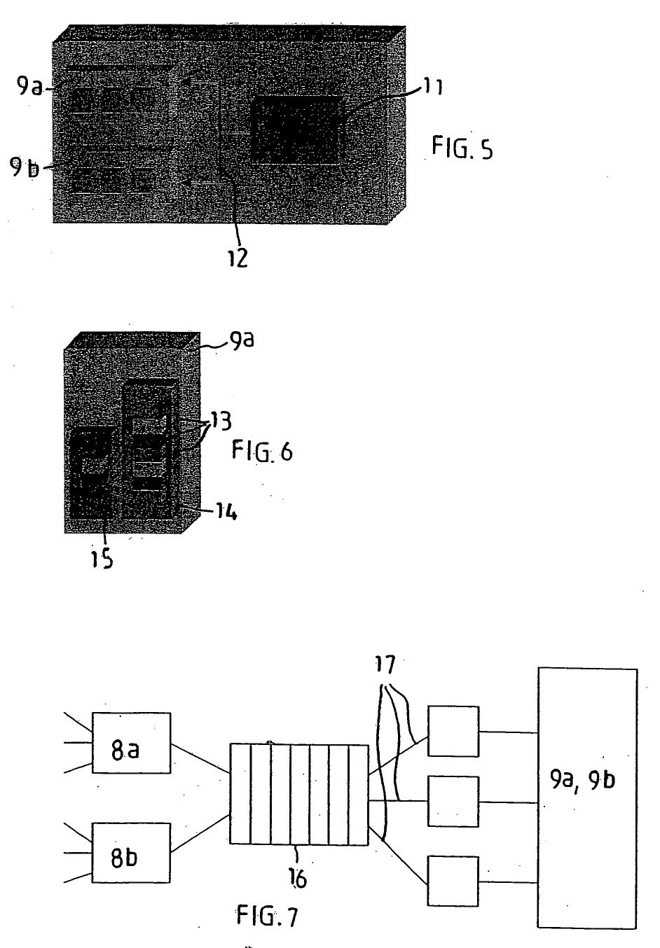

FIG. 5 shows an example of cleaning data contained in the cache, whilst FIG. 6 shows a modification of arrangement of the data in the cache.

Finally, FIG. 7 is a modification of the invention in which several clients access the system by means of a same inlet management module.

As shown very schematically in FIG. 1, according to the present state of the art, the client can address to a central system (CS) requests to obtain data concerning reservations for example of aircraft, or else the availability of places in all types of service.

This request can be represented by a “GET” operation sent to the central system (CS). This latter is connected to one or several inventory bases (I) of the condition of reservations in which the sought datum is located. By interrogation of these inventory bases (I), the central system (CS) can return a response to the client.

More precisely, according to the present state of the art, the different clients send an interrogation message to a member currently called “FRONT END” and said “FRONT END” member relays the demand to the client in the central system called “BACK END”. The FRONT END member thus constitutes an intermediary between the clients and the core of the central system. It is at this level that are sent the different message of the clients before their transmission. This type of organization generates a multiplicity of communications between the different members of the system and a large size of the assembly of the central system.

The reservation system according to the invention avoids such drawbacks.

In a way known per se, it integrates into a structure comprising a client portion with several client applications (19) and a server portion provided with a central portion (CS) and one or several inventory bases (I).

Processing requests according to the invention can take place in a complementary manner or by replacing the present process, as is previously described.

The inventory bases are generally databases made available by the provider of the service such as the aircraft company and it has updating of the condition of the reservations.

Again according to the present state of the art, and possibly in the structure of the invention, the server portion and the client portion communicate by means of a communication network 5.

Within the scope of the invention, the communication network 5 can include a wide-ranging network such as the Internet.

Characteristically, and as shown in FIG. 2, the system according to the invention comprises at least one cache (9a, 9b).

The cache is located in the server portion and contains reservation data. The caches (9a, 9b) are integrated into cache blocks (3a, 3b, 3c) shown in FIG. 2. In a manner known per se, the caches (9a, 9b) could be constituted by a volatile memory of the RAM type (Random Access Memory). Of course, a periodic safeguard of the data contained in these caches (9a, 9b) can be carried out with a non-volatile memory, on a disc.

In a manner intermediate between the different client applications (19) and the cache or caches (9a, 9b), the system here shown comprises interface applications (18). They permit the user to address requests to the cache and to receive data in response.

Again with reference to FIG. 2, the system comprises preferably one or several inlet management blocks (2a, 2b).

The intake management blocks (2a, 2b) communicate with the interface applications (18) by routing means (4). Any type of routing can be used according to the invention, which is not limited to a particular modification.

The structure comprised of intake management blocks (2a, 2b) of the routing means (4) of the interface applications (18) and the different cache blocks (3a, 3b, 3c) permit the formation of a functional unit called a server cache (1).

More precisely, in the server cache (1), the blocks are articulated preferably in the following manner.

As to the intake management blocks (2a, 2b), they comprise a plurality of intake modules (8a, 8b) in connection with the applications client (19) by means of the communication network (5).

According to a first modification, each input management module is connected to a single client application (19). There are thus as many modules (8a, 8b, 8c) as client applications (19) connected to the input management block (2a, 2b). To administer each input management module (8a, 8b), each input management block (2a, 2b) comprises an input manager (7a, 7b). It permits applying operating parameters to each input management module (8a, 8b).

An input management block (2a, 2b) can be connected to a cache block (3a, 3b) or to several, according to suitable routing conditions.

According to the example of FIG. 3, the input management block (2a) communicates with the cache block (3a).

This latter comprises a cache (9a) as described above which operates by means of a cache management application (10a).

This cache application (10a) provides the interface between the input management block and the cache block.

In the example of this figure, each client application (19) corresponds to an input management module (8a, 8b). According to a modification, several clients (19) can address their requests to a single input management module.

Thus, in the case of FIG. 7, the modules (8a, 8b) are connected to a file (16) operating according to the (first in, first out) logic adapted to receive the requests and to redistribute them in the order of input.

In this connection, at the output of the file (16) is a line group (17) transmitting requests to the cache (9a, 9b). The number of input management modules (8a, 8b) of the system can thus be limited.

FIG. 5 shows a preferred embodiment for cleaning the data contained in the cache (9a, 9b). To this effect, the system comprises a cleaning tool (11) addressing cleaning commands (12) to the different caches (9a, 9b). The procedures illustrated for this cleaning will be described later.

There will be set forth hereafter the operation of the system according to the invention and the process for processing and access which forms an integral part of it.

In this connection, one or several caches (9a, 9b) are created in the server portion to contain reservation data. The clients can access this to respond rapidly to requests without encumbering the rest of the central system as is explained above.

To expose data contained in the cache or caches (9a, 9b), there are added data to the cache (9a, 9b) by transfer from at least one inventory base (I).

An example of the successive operations permitting the addition of data to the cache (9a, 9b) is shown in FIG. 4.

According to this diagram, the client addresses a request generating a “GET” operation for interrogation of the cache (9a, 9b). If a positive response can be supplied by the cache (9a, 9b) to the “GET” interrogation, the data contained in the cache is returned to the client as a response.

If the cache does not contain the response requested by the client, the latter is addressed to the central system (CS) which is adapted to generate the response, by connection with the inventory bases (I). The data in response are returned by the central system (CS) and are added to the cache (9a, 9b) by a “PUT” operation.

In this way, a datum not previously contained in the cache will be memorized.

This series of operations can be carried out at the startup of the system according to the invention from a cache not containing any data but in which will be successively memorized the data according to the interrogations of the clients.

To avoid the cache being overloaded and so as to optimize the operation, it is important to proceed to an updating of the data which it contains.

In this connection, the process according to the invention proposes two separate procedures but which can be used simultaneously to effect cleaning of the data.

According to a first procedure, there is assigned to each datum a maximum duration of preservation. Periodically, the data contained in the cache (9a, 9b) are scrutinized to detect those whose retention time limit is exceeded.

These data are then deleted from the cache.

In this way, data that are too old and that no longer have a real and reliable character, are deleted.

Of course, the period of exposure according to this procedure is variable according to the nature of the contained data. By way of example, the time interval between two cleaning commands could be 60 seconds.

A second cleaning procedure can be used according to the process of the invention by replacing or complementing that of the first.

In this connection, there is assigned a size limit to the cache corresponding to the maximum size that it is desired to give to the cache. Moreover, there is assigned to it a threshold size of a value less than the limit size and corresponding to a size that is admissible for the good operation of the cache. For example, the threshold size could be fixed at 80% of the limit size.

When the limit size is reached, the contained data are deleted (9a, 9b) by decreasing order of age of use, until the threshold size is reached.

In this way, the very old data used are deleted to the extent necessary to reach an acceptable size for the cache.

Again so as to optimize the operation of the caches (9a, 9b), a particular mode of filing the data in the cache (9a, 9b) will be given hereafter.

Generally speaking, there is assigned to each datum to be memorized in the cache a key.

This key can be transformed in numerical value, commonly called “HASH CODE” according to hashing algorithms used at present.

There is moreover created a vector of lists 14 shown in FIG. 6 and comprising a series of compartments (13) generally called “BUCKET”. Each compartment (13) is adapted to contain one or several data.

There is assigned to each compartment (13) a numerical index which is a whole number extending from zero.

By way of example, a number of 20 011 compartments could be formed for a cache with a size limit of 51 200 Kilo Octets.

There is then carried out a correspondence between the key assigned to each datum and the numerical index of each compartment (13). This establishment of correspondence can be carried out by a modulation of the numerical key of the datum by the number of compartments (13) of the vector of lists (14).

The object of this correspondence is to memorize the data in a compartment (13) with a particular index and not to carry out a comparison of the data contained in the cache only for the data of a compartment (13) having the same index as that of the datum sought by the client.

In this way, the number of operations of comparison that are necessary is greatly reduced.

The number of values contained in a compartment (13) is not limited. It should be understood however that the fewer the values, the more the performance is good.

Again so as to optimize the operation of the cache (9a, 9b), only the access of the compartments (13) that are used could be blocked during processing of the requests. In this way, the processing of a request assigned to a compartment (13) does not block the operation of the other compartments (13). To do this, there are used selective access blocking means (15) also called semaphores or “MUTEX”.

A better management of concurrent requests is thus effected, fewer simultaneous requests being in danger of being processed in a same compartment (13).

### REFERENCES

1—Cache server

2a, 2b—Input management block

3a, 3b, 3c—Cache block

4—Routing means

5—Communication network

6a, 6b—Input port

7a, 7b—Input manager

8a, 8b—Input management modules

9a, 9b, 9c—Cache

10a, 10b—Cache management application

11—Cleaning tool

12—Cleaning command

13—Compartments

14—Vector of lists

15—Selective access blocking means

16—File

17—Group of lines

18—Interface application

19—Client application

CS—Central system

I—Inventory base

1. Process for treating and accessing data in a computer reservation system, comprising a server portion provided with a central system (CS) and at least one inventory base (I) of the condition of reservations, and a client portion comprising at least one client application (19), the server and client portions being connected by a communication network (5),
characterized by the fact that:
there is created at least one cache (9a, 9b) in the server portion, said cache (9a, 9b) containing reservation data;
there are added data to the cache (9a, 9b) by transfer from at least one inventory base (I);
there is created an interface application (18) between the cache (9a, 9b) and the client application or applications (19) such that its user can address requests to the cache (9a, 9b) and receive data in response.

2. Process for processing and accessing data according to claim 1, characterized by the fact that: if, upon a request to the cache (9a, 9b) by a client application (19), the cache (9a, 9b) does not contain the required data:
the request is treated in the central system (CS) by access to the inventory bases (I) for the condition of reservations, to find the requested data;
said data are added to the cache (9a, 9b);
the requested data are returned, in response to the client application (19).

3. Process for processing and accessing data according to claims 1 or 2,
characterized by the fact that:
the data contained in the cache (9a, 9b) are cleaned by use of the following procedure:
assigning a maximum preservation duration to each datum contained in the cache (9a, 9b);
periodically scrutinizing data contained in the cache (9a, 9b) to detect the data whose maximum duration of preservation has elapsed;
deleting data whose maximum duration of preservation has elapsed.

4. Process for processing and accessing data according to any one of claims 1 to 3,
characterized by the fact that:
the data contained in the cache (9a, 9b) are cleaned by using the following procedure:
assigning a limit size and a threshold size to the cache (9a, 9b), said threshold size having a value less by a predetermined margin than said limit value;
when the limit size is reached, deleting data contained in the cache (9a, 9b) by decreasing order of last use, to reach until the threshold size is reached.

5. Process for processing and accessing data according to any one of claims 1 to 4,
characterized by the fact that
the data in a cache (9a, 9b) are classified by:
assigning a key to each datum to be stored;
transforming the key into a numerical value;
creating a vector of lists (14) comprising a series of compartments (13) adapted to contain a list of several data;
assigning to each compartment (13) a whole number index extending from zero;
determining, for each datum, the index of the stored compartment by modulation of the numerical value of the key of the datum by the number of compartments (13);
storing the data in the compartment (13) thus identified.

6. Process for processing and accessing data according to claim 5,
characterized by the fact that
a datum in a cache (9a, 9b) is sought by transformation of the key into a numerical value and determination of the index of the storage compartment (13) by modulation of the numerical value of the key by the number of compartments, and by the fact that:
if a single datum is present in the compartment (13), the sought data is retrieved;
if no datum is present in the compartment (13) an absence information is retrieved;
if several data are present in the compartment (13) their keys are compared to determine the one which is effectively sought.

7. Process for processing and accessing data according to claim 6,
characterized by the fact that:
access is blocked only to those compartments (13) that are processing a request, to permit other processing of simultaneous requests in other compartments (13).

8. Computer reservation system comprising a server portion provided with a central system (CS) and at least one inventory base (I) of the condition of reservations, and a client portion comprising at least one client application (19), the server and client portions being connected by a communication network (5) adapted to use the process according to any of claims 1 to 7,
characterized by the fact that it comprises
at least one cache (9a, 9b) in the server portion, said cache (9a, 9b) containing reservation data;
at least one interface application (18) between the cache (9a, 9b) and the client application or applications (19) so that its user can address requests to the cache (9a, 9b) and receive data in response.

9. Computer reservation system according to claim 1,
characterized by the fact that:
it comprises, in the server portion, at least one cache server (I) comprising:
at least one cache block (3a, 3b, 3c) provided with a cache (9a, 9b) and an application (10a, 10b) for management of the cache (9a, 9b);
at least one input management block (2a, 2b) provided with a plurality of input management modules (8a, 8b) each receiving requests from one or several client applications (19) and managed by an input manager (2a, 2b).

10. Computer reservation system according to claim 9,
characterized by the fact that:
each input management module (8a, 8b) is assigned to a single client application (19).

11. Computer reservation system according to claim 9,
characterized by the fact that:
input management modules (8a, 8b) are assigned to several client applications (19) and their cache block (3a, 3b, 3c) comprises:
a file (6) adapted to receive requests from client applications (8a, 8b) and to redistribute them by order of input upon demand from the cache (9a, 9b).

12. Computer reservation system according to any one of claims 8 to 11,
characterized by the fact that:
the cache or caches (9a, 9b) comprise a vector of lists (14) comprising a series of compartments (13) adapted to contain a list of several data to which is assigned an index, for seeking a datum by the index of the compartment (13) in which it is stored.

13. Computer reservation system according to any one of claims 8 to 12,
characterized by the fact that:
it comprises a cleaning tool (11) adapted to address cleaning commands to the cache (9a, 9b) according to a predetermined procedure.
